(19) United States
(12) Patent Application Publication
(10) Pub. No.: US 2017/0307123 A1
(43) Pub. Date: Oct. 26, 2017

(54) CONNECTOR ASSEMBLY

(71) Applicant: Hsiu-Hsiung LIU, New Taipei City (TW)

(72) Inventor: Hsiu-Hsiung LIU, New Taipei City (TW)

(21) Appl. No.: 15/134,372

(22) Filed: Apr. 20, 2016

(51) Int. Cl. F16L 37/40; F16L 37/084

(52) U.S. Cl. CPC F16L 37/40; F16L 37/084

(57) ABSTRACT

A connector assembly has a main body, a valve, a spring, a quick connecting device, and a seal. The valve is moveably mounted in the main body and has an adaptor, a valve body, and a sealing assembly. The valve body is spaced from the adaptor and has a closed end away from the adaptor, an open end, and multiple through holes radially defined in the valve body. The seal is clamped between the valve body and the adaptor to connect the valve body with the adaptor and has a tubular sleeve and a clamped flange. The tubular sleeve has an end. The clamped flange is radially formed around and protrudes from the end of the sleeve and clamped between the open end of the valve body and the adaptor.

### BACKGROUND OF THE INVENTION

### 1. Field of the Invention

The present invention relates to a connector assembly, and more particularly to a connector assembly having an excellent leakage proofing effect.

### 2. Description of Related Art

A connector is applied to connect a pneumatic tool with a pressured air source to allow pressured air to be led to the pneumatic tool for work. With reference to FIG. 12, a conventional connector comprises a main body 80, a valve 82, and an O-ring 84. The O-ring 84 is mounted on an inner surface of the valve 82. When a plug 90 is inserted into an end of the main body 80, the valve 82 will be pushed to move relative to the main body 80 for two ends of the main body 80 to communicate with each other. The plug 90 will abut the O-ring 84 to provide a leakage proofing effect to the plug 90.

However, the O-ring 84 is held in an annular groove defined in the inner surface of the valve 82 and is easily detached from the groove due to the attachment or detachment of the plug 90 or the pressure of the pressured air. Consequently, the leakage proofing effect of the connector is lost. To re-assemble the O-ring 84 into the valve 82 is troublesome.

In addition, to enhance the combination of the O-ring 84 and the valve 82, an O-ring 84 with a larger diameter may be applied to prevent the O-ring 84 from being detached from the valve 82 unintentionally. However, the O-ring 84 with a large diameter will block a passage of the plug 90, so the air flow passing through the plug 90 will be reduced.

To overcome the shortcomings, the present invention tends to provide a connector assembly to mitigate or obviate the aforementioned problems.

### SUMMARY OF THE INVENTION

The main objective of the invention is to provide a connector assembly that can keep a seal from being detached from a valve unintentionally and can provide an excellent leakage proofing effect.

The connector assembly has a main body, a valve, a spring, a quick connecting device, and a seal. The main body is tubular and has two ends and two openings defined respectively in the ends of the main body. The valve is moveably mounted in the main body and has an adaptor, a valve body, and a sealing assembly. The adaptor has two open ends. The valve body is spaced from the adaptor and has a closed end away from the adaptor, an open end, and multiple through holes radially defined in the valve body. The sealing assembly is arranged between the valve body and the main body. The spring is mounted between the valve and the main body to provide a force for keeping the sealing assembly in a sealed condition. The quick connecting device is mounted on the main body. The seal is clamped between the valve body and the adaptor to connect the valve body with the adaptor and has a tubular sleeve and a clamped flange. The tubular sleeve has an end. The clamped flange is radially formed around and protrudes from the end of the sleeve and clamped between the open end of the valve body and the adaptor.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a connector assembly in accordance with the present invention;

FIG. 2 is an exploded perspective view of the connector assembly in FIG. 1;

FIG. 3 is a cross sectional side view of the connector assembly in FIG. 1;

FIG. 4 is an enlarged cross sectional side view of the connector assembly in FIG. 1;

FIGS. 5 to 7 show operational cross sectional side views of the connector assembly in FIG. 1 applied with different types of plugs;

FIG. 8 is an exploded perspective view of a second embodiment of a connector assembly in accordance with the present invention;

FIG. 9 is an operational cross sectional side view of the connector assembly in FIG. 8;

FIG. 10 is an exploded perspective view of a third embodiment of a connector assembly in accordance with the present invention;

FIG. 11 is an operational cross sectional side view of the connector assembly in FIG. 10; and

FIG. 12 is a cross sectional side view of a conventional connector applied with a plug.

### DETAILED DESCRIPTION OF PREFERRED EMBODIMENT

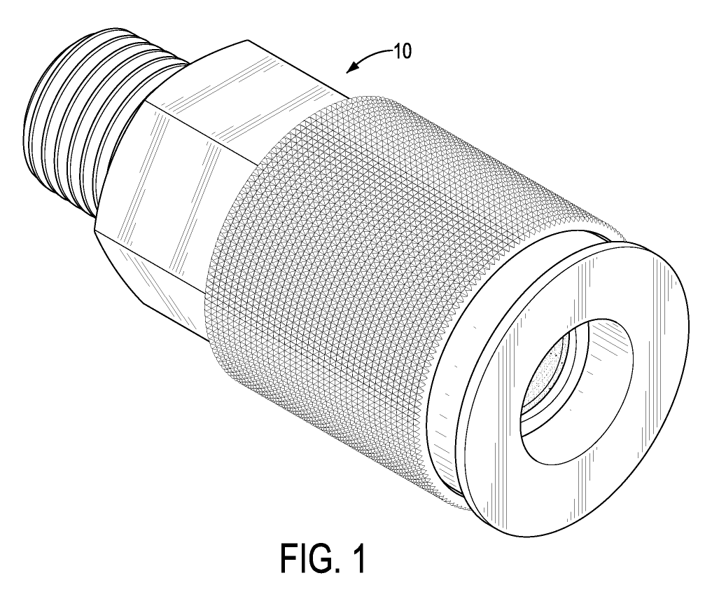

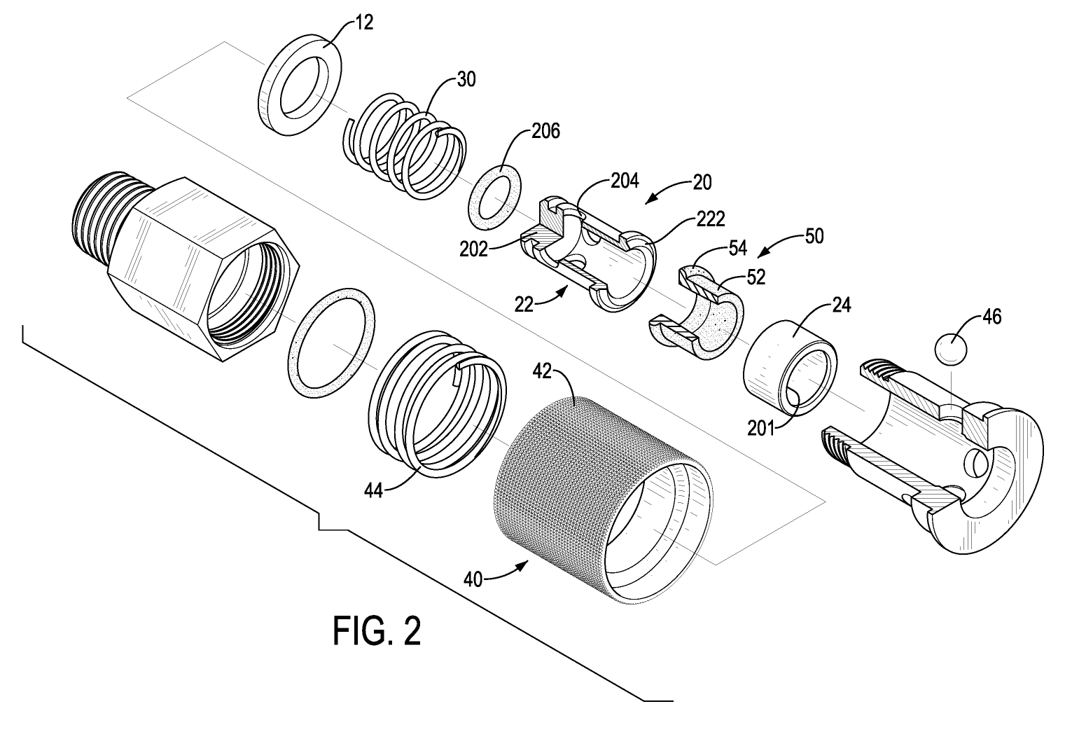

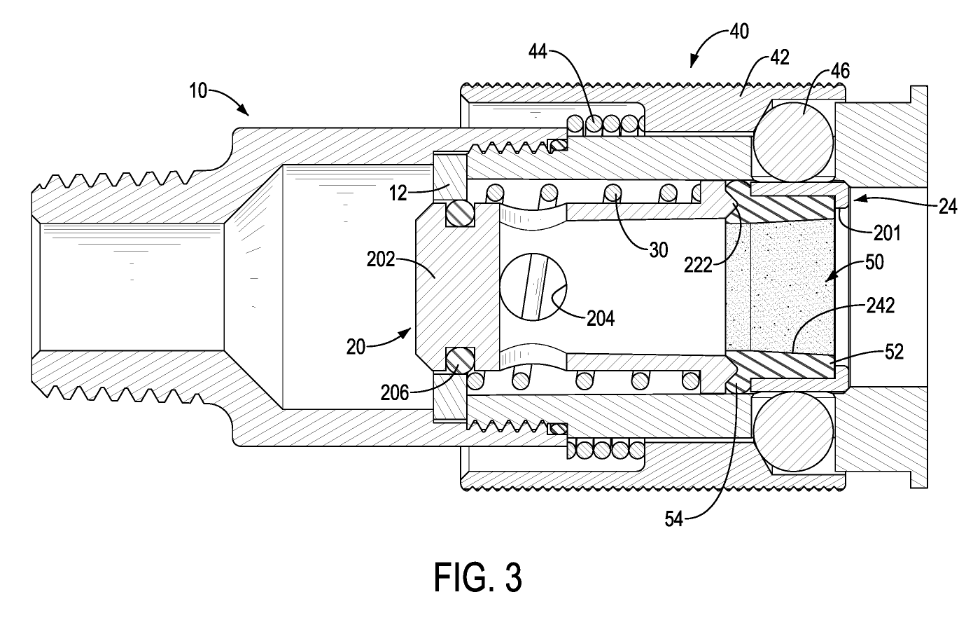

With reference to FIGS. 1 to 3, a connector assembly in accordance with the present invention comprises a main body 10, a valve 20, a spring 30, a quick connecting device 40, and a seal 50.

The main body 10 is tubular and has two ends and two openings defined respectively in the ends of the main body 10. Preferably, the main body 10 may be composed of two half bodies connected with each other by threading.

The valve 20 is moveably mounted in the main body 10 and has two ends. One of the ends of the valve 20 is an open end 201, and the other end of the valve 20 is a closed end 202. Multiple through holes 204 are radially defined in the valve 20 at positions adjacent to the closed end 202. A sealing assembly is arranged between the valve 20 and the main body 10 to seal a passage between the valve 20 and the main body 10 to prevent pressured air from flowing directly from one opening to the other opening of the main body 10. In practice, the sealing assembly may be conventional, or may comprise a sealing collar 12 and a sealing ring 206. The sealing collar 12 is mounted in the main body 10. The sealing ring 206 is mounted around the valve 20 at a position adjacent to the closed end 202 of the valve 20 and selectively abuts the sealing collar 12. With the abutment of the sealing ring 206 and the sealing collar 12, the passage between the valve 20 and the main body 10 can be sealed to prevent the pressured air from passing through the passage directly.

In addition, the valve 20 may be composed of a valve body 22 and an adaptor 24. The valve body 22 is spaced from the adaptor 24 and has a closed end and an open end, and the closed end of the valve body 22 is away from the adaptor 24 and is served as the closed end 202 of the valve 20. The through holes 204 of the valve 20 are radially defined in the valve body 22. The sealing ring 206 is mounted around the valve body 22. The adaptor 24 has two open ends, and the open end of the adaptor 24 that is away from the valve body 22 is served as the open end 201 of the valve 20.

The spring 30 is mounted between the valve 20 and the main body 10 to provide a force for keeping the sealing assembly in a sealed condition. Preferably, the spring 30 is mounted around the valve 20 and has two ends abutting respectively the valve 20 and the sealing collar 12.

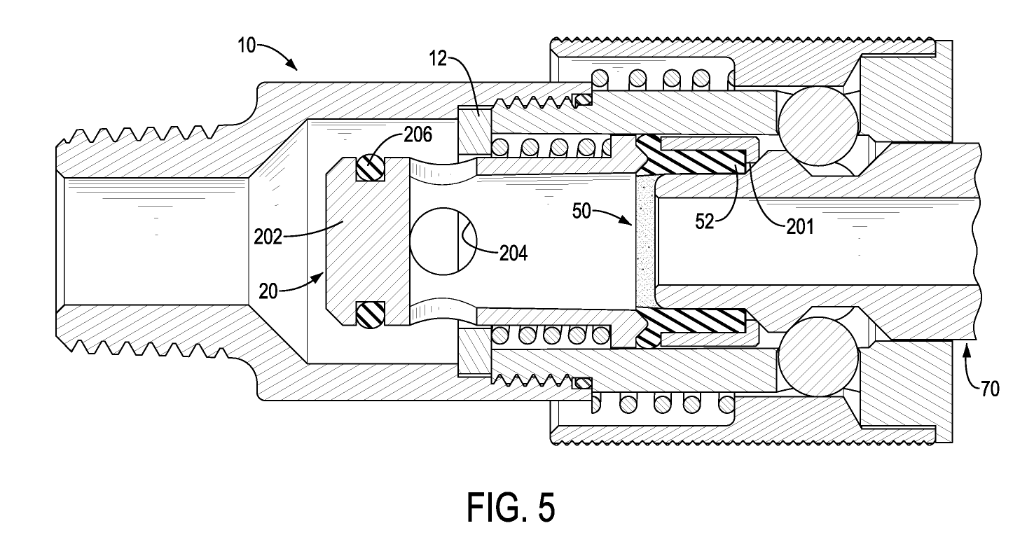

With further reference to FIG. 5, the quick connecting device 40 is mounted on the main body 10 and is adapted to engage with a plug 70 that is inserted into the main body 10 to securely connect the plug 70 with the main body 10. The quick connecting device 40 substantially comprises a sliding sleeve 42, a sleeve spring 44 and multiple engaging balls 46. The quick connecting device 40 may be conventional, and the detail thereof is omitted.

The seal 50 is mounted in an inner surface of the valve 20 at a position adjacent to the open end 201 of the valve 20. The seal 50 comprises a tubular sleeve 52 and a clamped flange 54. The clamped flange 54 is radially formed around and protrudes from an end of the sleeve 52. When the valve 20 is composed of a valve body 22 and an adaptor 24, the clamped flange 54 is clamped between the open end of the valve body 22 and the adaptor 24. The adaptor 24 has an inner surface and a holding recess 242 defined in the inner surface of the adaptor 24. The sleeve 52 of the seal 50 is mounted in the holding recess 242 in the adaptor 24. Accordingly, the valve body 22 can be connected with the adaptor 24 by the seal 50. In addition, the inner surface of the seal 50 may be flush with the inner surface of the valve 20.

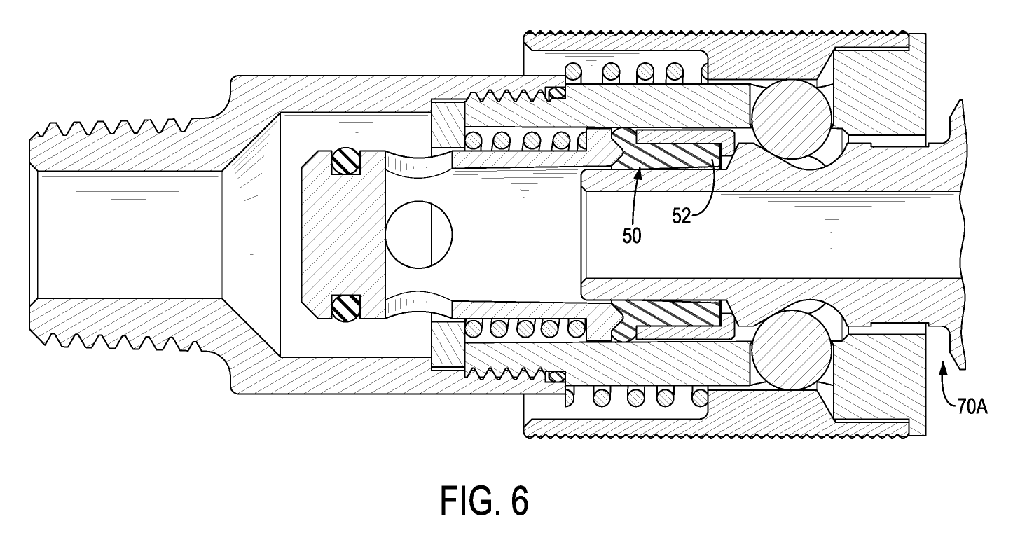

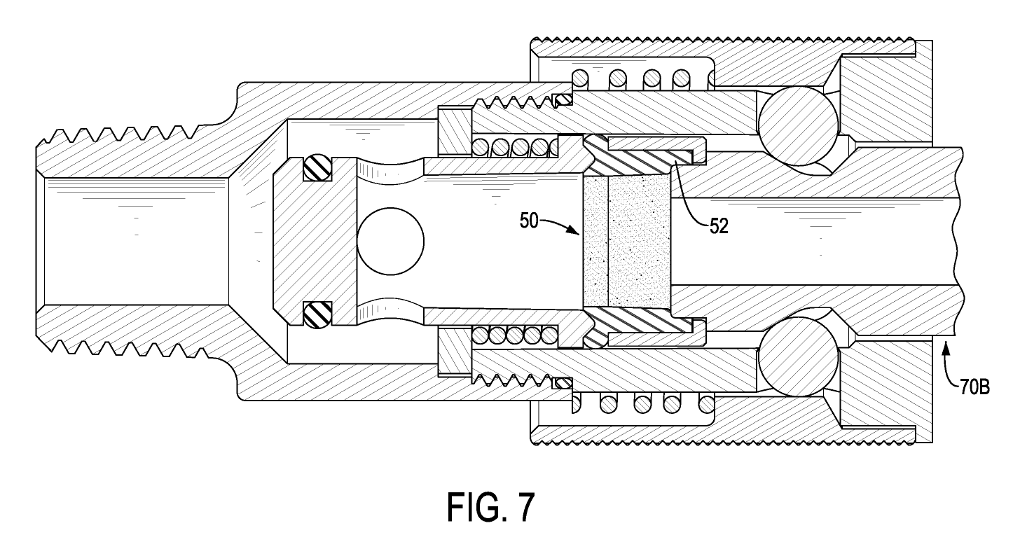

With reference to FIGS. 5 to 7, in use, the end of the main body 10 that is adjacent to the closed end 202 of the valve 20 is connected with a pressured air source via a hose. When a plug 70 that is connected with a pneumatic tool is inserted into the other opening of the main body 10, the plug 70 is inserted into the open end 201 of the valve 20 and abuts the seal 50. The valve 20 is pushed to move relative to the main body 10 by the plug 70, and the sealing ring 206 on the valve 20 leaves the position where the sealing ring 206 abuts the sealing collar 12. Consequently, pressured air will flow into the valve 20 via the passage between the valve 20 and the main body 10 and the through holes 204 in the valve 20. Thus, the pressured air will be led into the pneumatic tool via the open end 201 of the valve 20 and a passage of the plug 70 to enable the pneumatic tool to work.

Because the seal 50 comprises a tubular sleeve 52 and a clamed flange 54 and is engaged securely with the inner surface of the valve 20, the seal 50 is not easily detached from the inner surface of the valve 20 due to the attachment or detachment of the plug 70 or the pressure of the pressured air. Therefore, an excellent leakage proofing effect is provided. In addition, the seal 50 will not block the passage in the plug 70, so the air flow of the pressured air can be maximized.

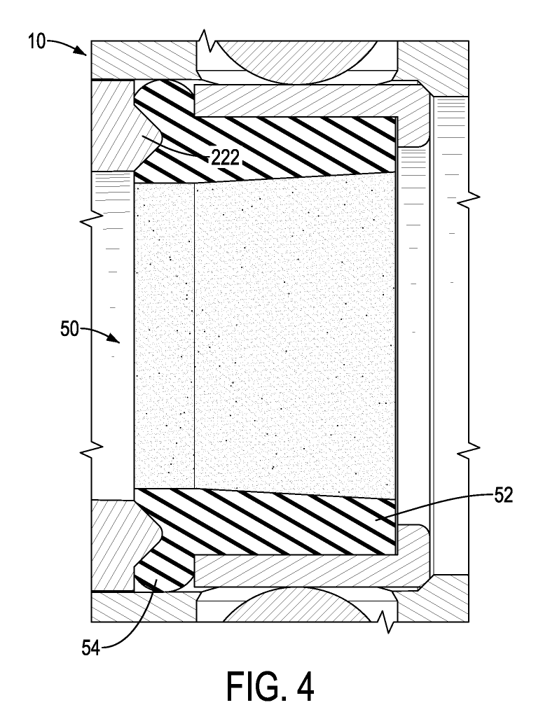

In addition, with reference to FIGS. 4 to 7, in the first embodiment of the present invention, the sleeve 52 of the seal 50 has an inner surface that is protruded to make the inner surface have multiple different inner diameters. Accordingly, the connector assembly in accordance with the present invention can be applied with different types of plugs 70,70A,70B, and the seal 50 can well abut the different types of plugs 70,70A,70B. Thus, the connector assembly in accordance with the present invention is versatile in use.

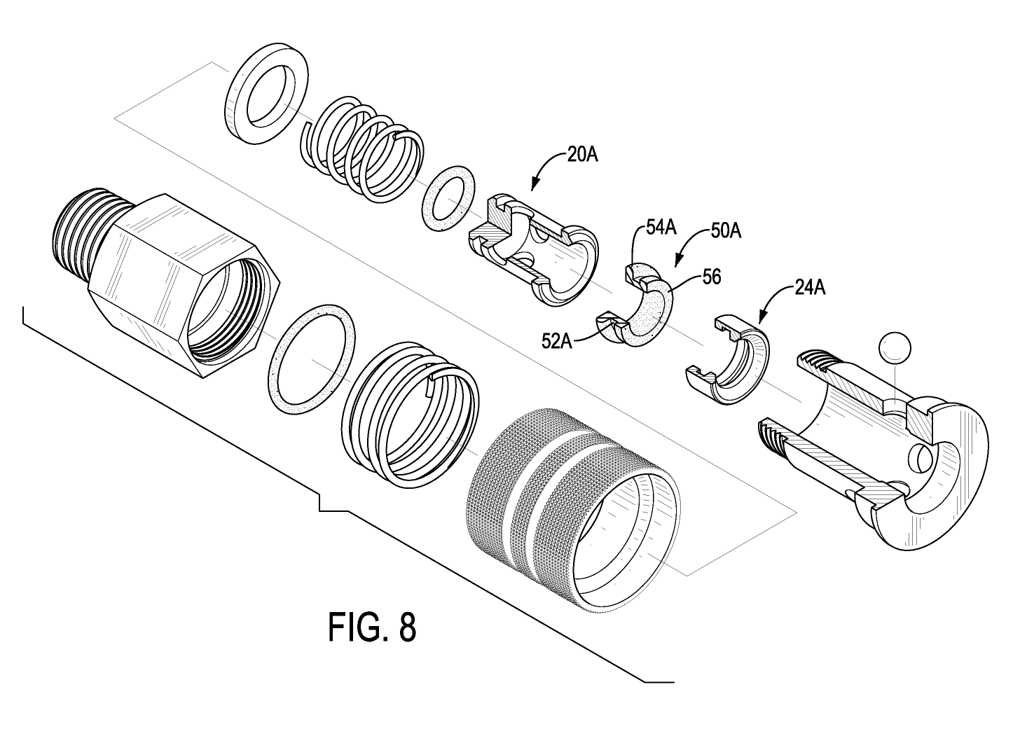

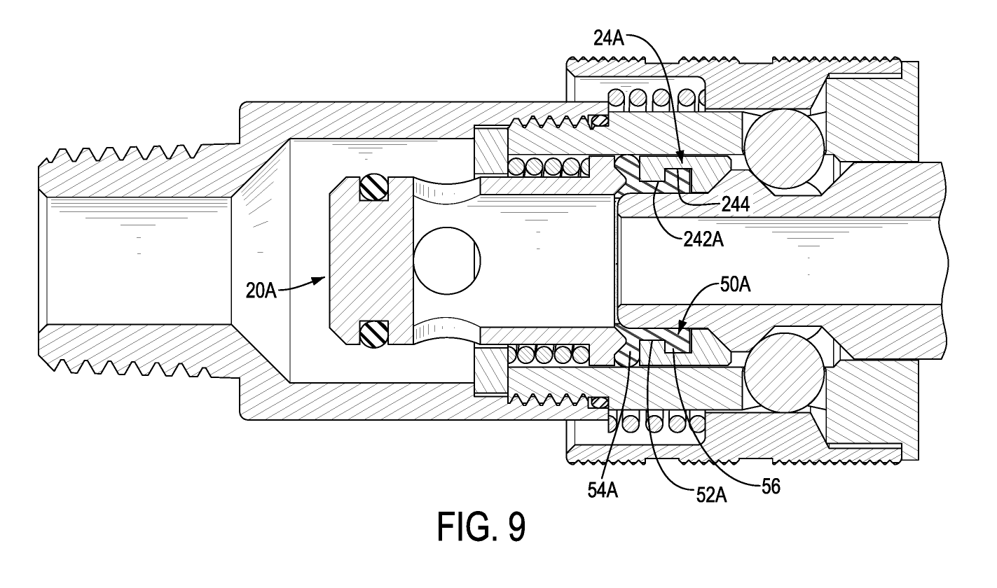

With reference to FIGS. 8 and 9, in the second embodiment of the present invention, the seal 50A further has an engaging flange 56 formed on the sleeve 52A at an end opposite the clamped flange 54A. The adaptor 24A further has an engaging groove 244 defined in the inner surface of the adapter 24A and engaged with the engaging flange 56 of the seal 50A. Accordingly, the combination of the seal 50A and the inner surface of the valve 20A can be enhanced. In addition, the inner surface of the sleeve 52A of the seal 50A may be flat to make the inner surface of the sleeve 52A have an even inner diameter.

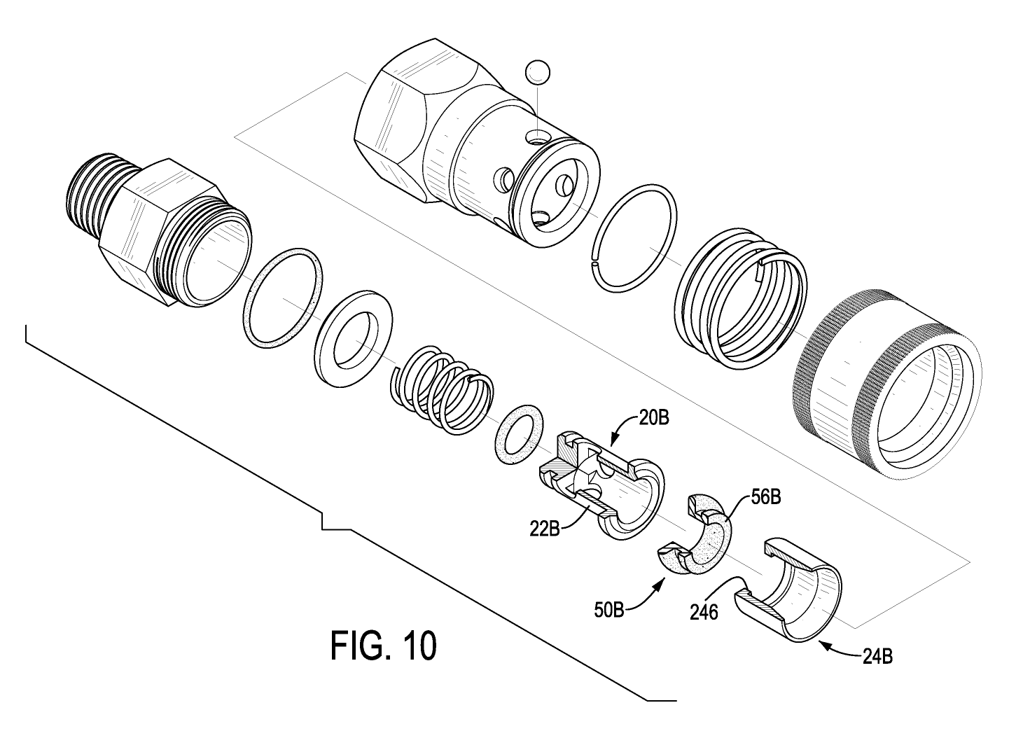

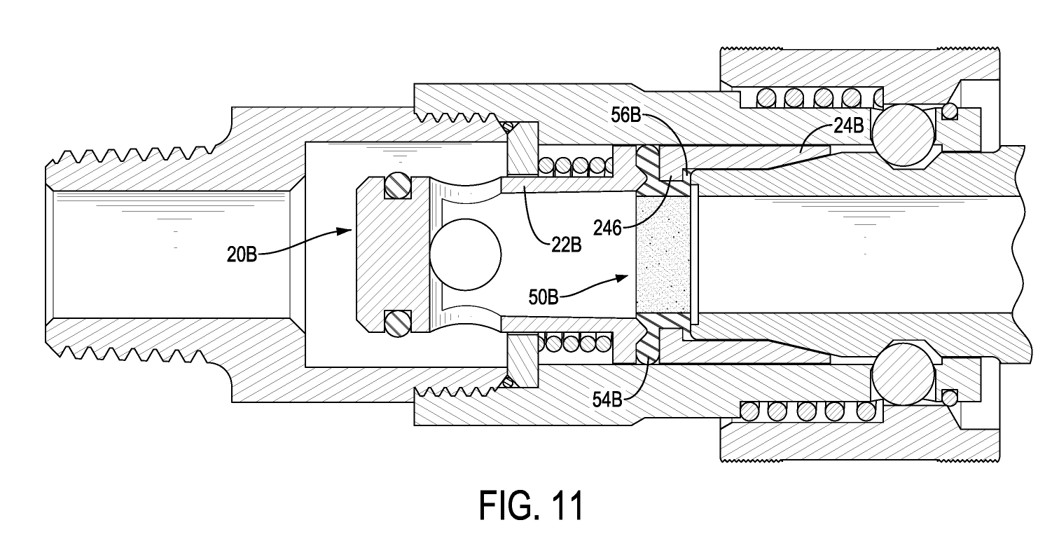

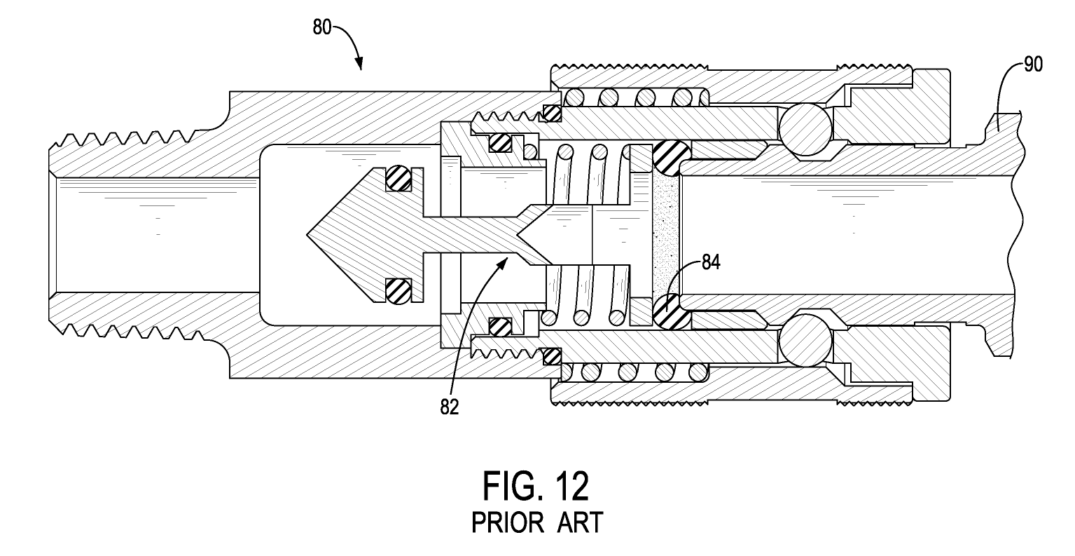

With reference to FIGS. 10 and 11, in the third embodiment of the present invention, the adaptor 24B of the valve 20B further has a clamping flange 246 formed on and protruding inward from the adaptor 24B at an end adjacent to the valve body 22B. The clamping flange 246 of the adaptor 24B is engaged with the engaging flange 56B on the seal 50B and is clamped between the engaging flange 56B and the clamped flange 54B of the seal 50B.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector assembly comprising:
a main body being tubular and having two ends and two openings defined respectively in the two ends of the main body;
a valve moveably mounted in the main body and comprising
an adaptor having two open ends;
a valve body spaced from the adaptor and having a closed end away from the adaptor, an open end, and multiple through holes radially defined in the valve body; and
a sealing assembly arranged between the valve body and the main body;
a spring mounted between the valve and the main body to provide a force for keeping the sealing assembly in a sealed condition;
a quick connecting device mounted on the main body; and
a seal clamped between the valve body and the adaptor to connect the valve body with the adaptor and comprising
a tubular sleeve having an end; and
a clamped flange radially formed around and protruding from the end of the sleeve and clamped between the open end of the valve body and the adaptor.

2. The connector assembly as claimed in claim 1, wherein the adaptor has an inner surface and a holding recess defined in the inner surface of the adaptor; and
the sleeve of the seal is mounted in the holding recess in the adaptor.

3. The connector assembly as claimed in claim 2, wherein the seal further has an engaging flange formed on the sleeve at an end opposite the clamped flange; and
the adaptor further has an engaging groove defined in the inner surface of the adapter and engaged with the engaging flange of the seal.

4. The connector assembly as claimed in claim 1, wherein
the seal further has an engaging flange formed on the sleeve at an end opposite the clamped flange; and
the adaptor further has a clamping flange formed on and protruding inward from the adaptor at an end adjacent to the valve body; and
the clamping flange of the adaptor is engaged with the engaging flange on the seal and is clamped between the engaging flange and the clamped flange of the seal.

5. The connector assembly as claimed in claim 4, wherein the valve body further has an abutting flange formed on the open end of the valve body and abutting against the seal.

6. The connector assembly as claimed in claim 5, wherein the sleeve of the seal has an inner surface that is protruded to make the inner surface have multiple different inner diameters.

7. The connector assembly as claimed in claim 6, wherein the sealing assembly comprises
a sealing collar mounted in the main body; and
a sealing ring mounted around the valve body at a position adjacent to the closed end of the valve body and selectively abutting the sealing collar.

8. The connector assembly as claimed in claim 7, wherein the spring is mounted around the valve and has two ends abutting respectively the sealing collar and the valve.

9. The connector assembly as claimed in claim 5, wherein the sleeve of the seal has a flat inner surface to make the inner surface have an even inner diameter.

10. The connector assembly as claimed in claim 9, wherein the sealing assembly comprises
a sealing collar mounted in the main body; and
a sealing ring mounted around the valve body at a position adjacent to the closed end of the valve body and selectively abutting the sealing collar.

11. The connector assembly as claimed in claim 10, wherein the spring is mounted around the valve and has two ends abutting respectively the sealing collar and the valve.

12. The connector assembly as claimed in claim 1, wherein the sleeve of the seal has an inner surface that is protruded to make the inner surface have multiple different inner diameters.

13. The connector assembly as claimed in claim 12, wherein the sealing assembly comprises
a sealing collar mounted in the main body; and
a sealing ring mounted around the valve body at a position adjacent to the closed end of the valve body and selectively abutting the sealing collar.

14. The connector assembly as claimed in claim 13, wherein the spring is mounted around the valve and has two ends abutting respectively the sealing collar and the valve.

15. The connector assembly as claimed in claim 1, wherein the sleeve of the seal has a flat inner surface to make the inner surface have an even inner diameter.

16. The connector assembly as claimed in claim 15, wherein the sealing assembly comprises
a sealing collar mounted in the main body; and
a sealing ring mounted around the valve body at a position adjacent to the closed end of the valve body and selectively abutting the sealing collar.

17. The connector assembly as claimed in claim 16, wherein the spring is mounted around the valve and has two ends abutting respectively the sealing collar and the valve.

18. The connector assembly as claimed in claim 11, wherein the sealing assembly comprises
a sealing collar mounted in the main body; and
a sealing ring mounted around the valve body at a position adjacent to the closed end of the valve body and selectively abutting the sealing collar.

19. The connector assembly as claimed in claim 18, wherein the spring is mounted around the valve and has two ends abutting respectively the sealing collar and the valve.
